(19) United States
(12) Patent Application Publication
(10) Pub. No.: US 2013/0290150 A1
(43) Pub. Date: Oct. 31, 2013

(54) METHOD AND SYSTEM FOR OPTIMUM INVENTORY MANAGEMENT

(71) Applicants: Samaradasa Weerahandi, Pittstown, NJ (US); Dilip Patel, Edison, NJ (US)

(72) Inventors: Samaradasa Weerahandi, Pittstown, NJ (US); Dilip Patel, Edison, NJ (US)

(21) Appl. No.: 13/458,151

(22) Filed: Apr. 27, 2012

(51) Int. Cl. G06Q 10/08

(52) U.S. Cl. 705/28

(57) ABSTRACT

Optimum Inventory Management is important in a variety of applications ranging from managing stocks of consumer perishables of a supermarket chain to managing number of magazines to be distributed to retail stores. Currently inventory decision making are done at certain segment or bucket level, thus making the implementation sub-optimal. In this invention, we develop a method and a system for performing analysis at much finer level of granularity. Moreover, widely used inventory models are not capable of handling the display effect and its interaction with price. Inventory decision making at customized scenarios is accomplished by leveraging business intelligence software that allow one to write scripts to perform real-time analysis under user specified input parameters. Inventory optimization at finer level of granularity is accomplished using a model that incorporates various drivers including the display and price effects, and latest statistical techniques to estimate the model with historical data.

### BACKGROUND OF THE INVENTION

Inventory Management problems arise in a variety of applications such as managing stocks of consumer perishables for individual stores of a super market chain, managing inventory of rent-a-car chain by car category, newspaper/magazine distribution to retail stores, and so on. Currently inventory decision makings are done at certain Segment or Bucket level without taking advantage of the demand distribution of individual stores/branches. For example, in magazine distribution, buckets are comprised of Class of Trade and classes of stored grouped depending on their sales volume. Then stock formulas are computed for separate buckets rather than for individual stores within each bucket. Since the formulas do not take advantage of sales distribution of individual stores, such solutions are sub-optimal resulting in too many unsold stock, outdated stock, or inadequate stock.

Current inventory management systems are more focused on keeping stock of various available products or raw materials required for products, and for tracking available supply and order based on current inventory by store or warehouse. Rather than optimizing them using a demand model taking advantage of on latest sales patterns, price effects, and display effects in a systematic manner, current systems use sub-optimal bucket based formulas for inventory to be managed from a centralized location.

The inventories are calculated either by a system or manually using standalone tools and are not performed at most granular level, but rather by area, district, state, warehouse, region, and so on. Then they are applied to actual distribution outlet using simple formulas.

Most existing inventory systems work in the following manner:
System stores certain historical data in simple files or local databases.
Central manager or programs run available inventory method to get required inventory for various outlet centers. Normally this is done without taking advantage of detailed information at lowest level of application such as sales patterns at individual store attributes and historical sales patterns.
System or user doesn't have much flexibility to plug different scenarios as deemed required at granular level, thus making ad hoc inventory decisions.
Results are in simple formats with limited flexibility for user to fine tune inventory decision at individual store level.
In current systems the end user, or the manager who runs scenarios for a certain set of stores has no systematic way of dynamically trying out different scenarios real-time to optimize inventory with own input and latest information.

Moreover, widely used inventory models have ad hoc methods of handling pricing effects and are not capable of handling the display effect of inventory and its interaction with price thus making solutions sub-optimal. For example, in such inventory models as the classical newsboy problem, it is assumed that the demand distribution is exogenous and is independent of the stock. The literature in inventory management provides evidence against this assumption in various applications and show that consumer demand heavily depends on the stock due to display effect. The assumption is easy to relax when it depends on quantities such as promotions and price as discussed by Achabal, McIntyre, and Smith (1990), and Aydin and Porteus (2006), but the problem of parameter estimation is not easy. The problem is even more difficult when the demand depends on the displayed inventory, as usually the case.

### DESCRIPTION OF THE INVENTION

To overcome above described drawbacks, in this invention we develop a method and a system for performing analysis at much finer level of granularity and to deliver results in the form of analytics to appropriate managers, so that the managers can run such analytics under appropriate scenarios for the business jurisdiction they manage.

Moreover, as detailed below, we provide appropriate models for incorporating the original price, sale price, and the display effect that ignores in classical approach for simplicity and mathematical tractability. In this invention, we provide explicit formulas for optimum inventory management when the demand distributions transformations of the standard normal distribution and provide also algorithms to find the optimum inventory for other distributions. With widely used distribution functions, this invention provides explicit formulas for the profit functions involving no numerical integration. One can simply enumerate them over a range of feasible values to find the optimum inventory level subject to user specified inventory constraints.

Inventory decision making at customized scenarios is accomplished by leveraging business intelligence software that allow one to write scripts to perform real-time analysis under user specified input parameters obtained via a web-based or desktop user interface. The invention also specifies various components of a typical inventory management system comprised of a number of modules. As described in the above claims, the modules perform various functions in the stages of formulating and calibrating a demand model, preparing input for real-time data analysis, preparing output from analysis, and for delivering results via web and e-mail, in particular. The demand model identification and model parameter estimation (referred to as ‘model calibration’) module identifies the functional form of the statistical model, and significant attributes/categorical variables and quantitative variables that could play an important role in inventory decision making.

The model parameters are estimated using a set of historical data based on a period that is long enough to capture such effects as demand curve for each product being analyzed, including trend, seasonality, the effect of the stock on demand, and relationship with the price of the product. After the model has been calibrated it is applied at the lowest granular level of inventory management so that inventory decisions can be made at such level or at higher level of management hierarchy by rolling up the lower level results. In applications involving store level decision making, the system prepare a data file in the form of a data table or data cube with store IDs, store attributes, and such information as the average of quantitative variables for the latest period along with optimized inventory under user specified inventory constraints. As described below, the results can be delivered via web and e-mail, in particular. Store level optimized inventory by product and rolled-up inventory could be run as a web application that a user can access over the internet or the intranet of the business or run on user's desktop. The system output can be delivered in various electronic formats such as Excel, CSV along with Excel Pivot table for rolling up data in alternative ways to help end users can better understand the results and easily make decisions.

We now describe details of the components of the invention summarized above.

### The Inventory Management Problem

Consider the problem of determining the optimum re-stock level for a consumer good during a period of stock management. While the period for restocking tend to be one day for daily newspapers and such food items as fish, for most consumer perishables, such as eggs, juice, bread, and even magazines it could be one week and one month in some cases. The period could be even as high as one quarter or one year for such applications as inventory management problems in the airline and ‘rent-a-car’ industries. In the method and system proposed in this invention, one can use widely used inventory management models available in the literature and proceed with the parameter estimation and model implementation described below. We provide below much richer model that can be used regardless whether or not the inventory display affects the demand for the product or not.

### The Enhanced Demand Model

To be specific, consider the problem of inventory management in dealing with a consumer perishable with the understanding that the model can be easily leveraged to such problems as rent-a-car problem with minor modifications. Let X denotes the demand for the consumer perishable during a certain period, a random variable that can vary from one period to another due to known factors and due to the random nature of consumer demand. The known factors, which we denote by vector Z, could include such variables as
Price of the good at the beginning of the period or unit revenue
Proposed sale price, if any, for units of perishable left unsold after a certain fraction of the re-stocking period, as a fraction of the original price
Average price of competing brands
Trend
Season of the year
Holiday weeks
Off holiday weeks
Periodic events
Etc.

Let f_{θ}(x;a) be the probability density (or mass) function of the demand X that possibly depends on the stocking level a being used, where θ is a set of unknown parameters. The dependence of the demand distribution on a should be modeled through an appropriate parameter such as the location parameter, so that any result based on the model will have desirable properties such as the location invariance and the scale invariance. To be specific suppose there exists an increasing function Y=g(X), such as the widely used transformations g(X)=X or g(X)=log(X), so that a linear function of the form E(T)=β(a)=α(Z)+βA(a) serving as a location parameter of the transformed distribution. For example, one can set A(a)=log(a) for diminishing display effect with excessive stock. Moreover, in most applications it is assumed that α(Z) has a linear structure in the transformed scale; i.e.

α(Z)=α₀+α₁Z₁+α₂Z₂+ . . . +αᵣZᵣ, (1)

where Zᵢ's represent transformations of the above quantitative factors such as the original price and sale price while handling categorical variables such as season of the year and holiday weeks using dummy variables.

The problem is to determine the optimum re-stocking level in terms of revenue and cost coefficients. It is possible to structure the cost function in alternative ways, but the structures of the underlying objective function to be optimized have a similar form. In the simplest form, when a product with unit cost c is sold at a revenue of r per unit, the expected profit function at inventory level a can be expressed as P_{θ}(a)=rS_{θ}(a)−ca, where

$$\begin{matrix}{S}_{θ} ( a ) = {\int }_{x \leq a}^{ } {xf}_{θ} ( x ; a ) d x + {\int }_{x > a}^{ } a {f}_{θ} ( x ; a ) d x \\ = a - {\int }_{x \leq a}^{ } ( a - x ) {f}_{θ} ( x ; a ) d x\end{matrix}$$

is the expected sales at the inventory level a. More generally, in inventory problems of alternative forms, the objective function to be maximized can be expressed as

$$\begin{matrix}{R}_{θ} ( a ) = t a - {\int }_{x \leq a}^{ } ( a - x ) {f}_{θ} ( x ; a ) d x , & ( 2 ) \\ or as & \\ {R}_{θ} ( a ) = t a - {\int }_{x \leq a}^{ } {F}_{θ} ( x ; a ) d x , & \end{matrix}$$

where F_{θ}(x;a) is the cumulative distribution function, t is a known function of cost and revenue coefficients. For example, in the above case t=(r−c)/r and P_{θ}(a)=rR_{θ}(a).

In general, the algorithms developed below in our invention works with any monotonic cost function c(a), such as c(a)=c₀+c₁ log(a), in place of ca. With such non-linear cost functions, we simply replace to by the appropriate t(a) function.

### Parameter Estimation

Computation of the demand distribution and follow-up optimization of the inventory requires estimation model parameters such as the coefficients of the Trend, Seasonality, Original Price, and Sale Price by each product. Usually, while estimation of such variables as trend and Seasonality is easy, estimation of such variables as the price elasticity is not an easy task because sales data from one week to next can fluctuate substantially while demand distribution is something that can change over time. In fact, use of ad hoc methods or ordinary least squares regression would not yield even the right sign of parameters for many stores, due to noisy nature of data. For example, although the price variable is supposed to be negatively correlated with the demand, parameters estimated by such methods will not necessary have the right sign for price effects. This type of problem can be alleviated by taking advantage of Mixed Models and estimating parameters using what is known as Best Linear Unbiased Predictor (BLUP).

To describe the idea in Mixed Model approach, let us re-write Model (1) as

Yᵢₜ=α(Zᵢₜ)+β log(αᵢₜ)+γᵢWᵢₜ+εᵢₜ, (3)

where Wᵢₜ is a variable for at store i at time t, such as log(price), whose coefficient, γᵢ by store i is difficult to estimate by ordinary regression and εᵢₜ˜N(0,σ²). Also assumed that the variables have already been transformed, via de-meaning or some other standard approach, to make simultaneous estimation of parameters is possible. Then, in a Mixed Model setting, we can include fixed effect of Wᵢₜ also in α(Zᵢₜ) and assume the γᵢ are random effects, representing deviation of individual store coefficient from average effect for all sores. Moreover, assume in a Mixed Model setting that γᵢ˜N(0,σ_{γ}²). If the assumption of normal distribution is not appropriate, one can work with such distributions as log-normal, Poisson, and use appropriate parameter estimation methods available in the statistical literature using widely used software packages.

After formulating in a Mixed Model setting, say under the normal distribution, all parameters of the model can be estimated using such software solutions as SAS PROC MIXED or SPlus lme. Instances of sellouts are handled by censored data methods. It should be noted that procedures such as ML and REML employed in PROC MIXED frequently do not converge when its estimate of the variance component σ_{γ}² becomes negative, a drawback of ML and REML thus preventing us estimating BLUP of parameters, a function of variance components and Least Squares Estimates. In such situations, one can use the Generalized Point Estimation approach introduced by Weerahandi (2012). Once the fixed and random effects are estimated estimates of coefficients of such variables as Price and Sale Price elasticities can be obtained by adding the fixed effects and random effects of Wᵢₜ variables.

### Model Implementation and Real-Time Inventory Optimization

In this section we describe details of the system for implementing the Inventory Optimization:

1. Model Calibration
Model parameters are estimated periodically since sales patterns can change over time. As illustrated by FIG. 1 below, an analyst or a statistician obtain latest input data for each product of interest from various relational databases, or as text, excel, csv, files and convert them into data objects such as SAS, SPSS, R, and Splus data objects. Such data typically contain longitudinal store level information, including historical sales, sellout occurrences, historical prices, sales prices, and other relevant information such as seasonality. Before analysis, the data are cleaned and organized as dependant variable representing the Sales or Demand and independent variables that describe variation of demand, including price, trend, indicators for sold-out occurrences, and seasonality.
A statistical program/script is written such statistical languages as SAS, SPSS, R, Splus, or other widely used computer programming languages such as Java, C, and C++. Analysts try out alternative linear or non-linear models with alternative functional forms, handle outliers and sold-out situations, and detect the model that best fit the data. The final model output, in terms of estimated model parameters and model structure, is stored in either in a relational database, or as text, excel, or csv files, or statistical data objects such as SAS, SPSS, R, S+, or any other format.

2. Real-Time Inventory Optimization
The demand model calibrated as described above, is applied in real-time when a user invokes the implementation part of the system via an interface such as a web interface. As illustrated by FIG. 2 below, the system first takes current period data from various sources for the independent variables of the model including the store level information and seasonality, the use user specified inventory constraints, the initial price and the sale price for each product entered through the interface or imported from a file. Assume without loss of generality that sale price is a fraction of the original price. Then the demand model predicts expected demand for the planned period, including the sale period, using the calibrated model and the current values of the explanatory variables. And then the algorithm described below is used to optimize inventory by product at most relevant granular level, such as at the individual store level based on the expected demand distribution for each product by store. This is accomplished by the system by calling an optimization function and computing the optimum inventory levels for each perishable.

With the particular class of models, formulas, and the parameter estimation method described above, the profit function and the optimum stock level for each product by store/unit is carried out by calling a statistical function performing the following steps:
Compute each of the values of explanatory variables Z₁, Z₂, . . . , Zᵣ for the period of re-stocking, including the price and proposed sale price as a fraction of the original price
Estimate α(Z) using the formula α(Z)=α₀₊α₁Z₁+α₂Z₂+ . . . +αᵣZᵣ and the parameters estimated above based on the latest window of historical data
Define a function/subroutine to compute μ(a)=α(Z)+βA(a) for any given value of a and estimated parameters if α(Z).
If the assumed demand distribution is Normal, then the profit function at stock level a can be computed using the formula

$${R}_{θ} ( a ) = ta - ( a - u ( a ) ) Φ ( \frac{a - μ ( a )}{σ} ) - σ φ ( \frac{a - μ ( a )}{σ} ) ,$$

where φ(.) is density function of the standard normal distribution and χ is the cumulative distribution function of the standard normal distribution. In particular, if the mean function is of linear form as μ(a)=α+βa, then the optimum inventory in the absence of constraints can be easily computed as

$${a}_{0} = α + \frac{σ}{1 - β} {Φ}^{- 1} ( \frac{t}{1 - β} ) ,$$

provided that β<1 and closer to 0 than 1 and t=(r−c)r, c being the cost per unit and r being the original unit price.
If the assumed demand distribution is Lognormal, then the profit function will be of the form

$${R}_{θ} ( a ) = M ( a ) Φ ( \frac{log ( a ) - μ ( a )}{σ} - σ ) + a ( t - 1 ) Φ ( \frac{log ( a ) - μ ( a )}{σ} ) ,$$

where M(a)=exp(μ(a)+σ²/2).
If any other distribution is assumed, define a function/subroutine to compute the profit function by Monte Carlo integration using the function

$${R}_{θ} ( a ) = ta - {\int }_{x \leq a}^{ } ( a - x ) {f}_{θ} ( x ; a ) d x ,$$

where f_{θ}(x;α) is the probability density function of the appropriate demand distribution. In doing so using Mone Carlo samples,
generate a large number of random samples, say N samples, from the distribution of X,
using the Xᵢ values of X not exceeding the stock leve a, compute the sum S(a)=sum(a−Xᵢ),
for a pericular value of a, compute the profit as ta−S(a)/N.
Subject to user specified constraints on the stock a, evaluate the profit function using the appropriate formula above, over the range of feasible values a to the nearest integer
Set the optimum stock as the value of a at which the profit function is maximized within the range of feasible values of a subject to the user specified constraints.
It should be noted, as pointed out before, that when the cost function is non-linear, we can carry out the above calculation of profit function with no additional numerical burden by simply replacing the to term by the appropriate function t(a), such as t(a)=t₀+t₁ log(a).

3. Delivery of Results
The computed optimum inventory results are then presented, along with other useful information such as the sales and revenues in the previous period by product, to the user running the model. The system may presents results to users running the model in desired graphical forms and data exported in desired formats such as Excel sheet, Excel Pivot table, Text File, etc. The results can be delivered to mangers taking action via alternative methods such as the company Intranet, Internet, e-mail, and fax.

### DESCRIPTION OF THE DRAWINGS AND ILLUSTRATION

In the Figures:

FIG. 1 describes the steps involved in calibration of the demand model with historical sales data. The details are disused in the ‘Model Calibration’ subsection of the ‘Model Implementation and Real-Time Inventory Optimization’ section above.

FIG. 2 describes the steps involved in real-time application of the estimated demand model to the latest period of inventory management. The details are disused in the ‘Real-Time Inventory Optimization’ subsection of the ‘Model Implementation and Real-Time Inventory Optimization’ section above.

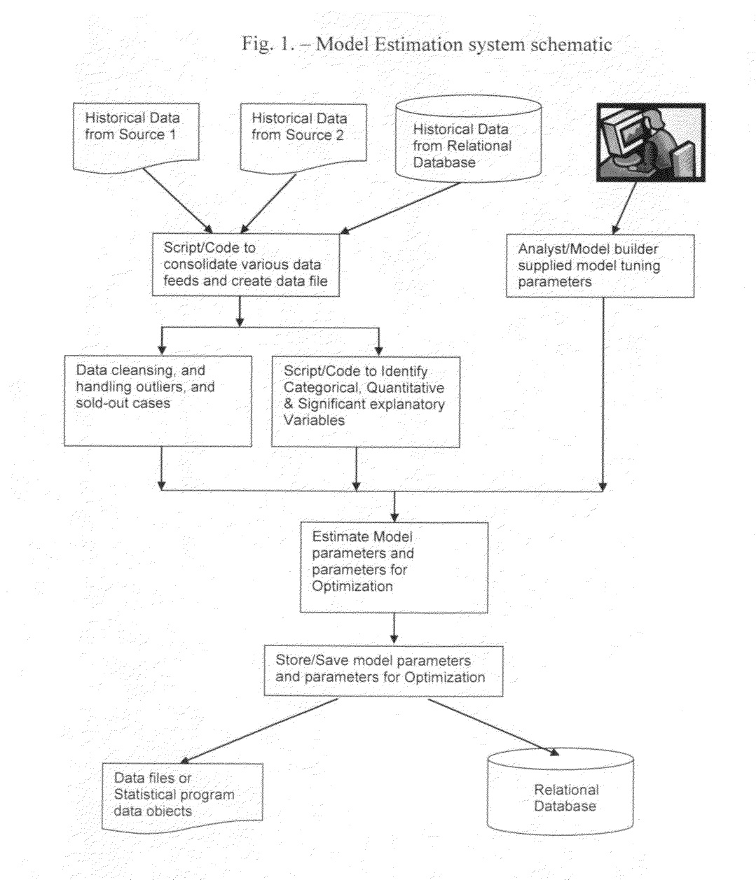

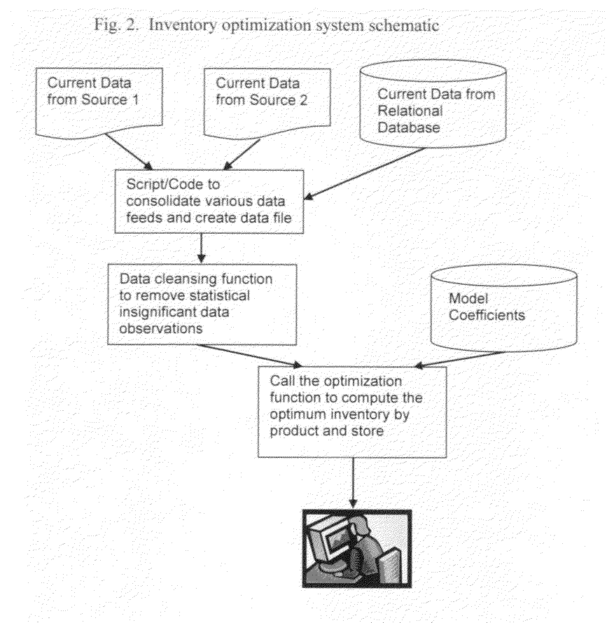

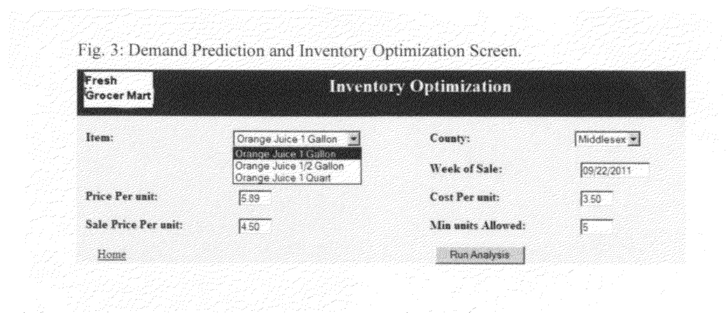

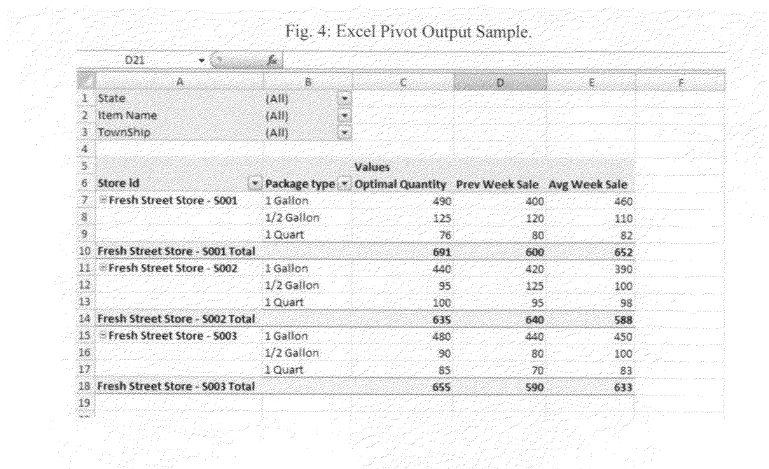

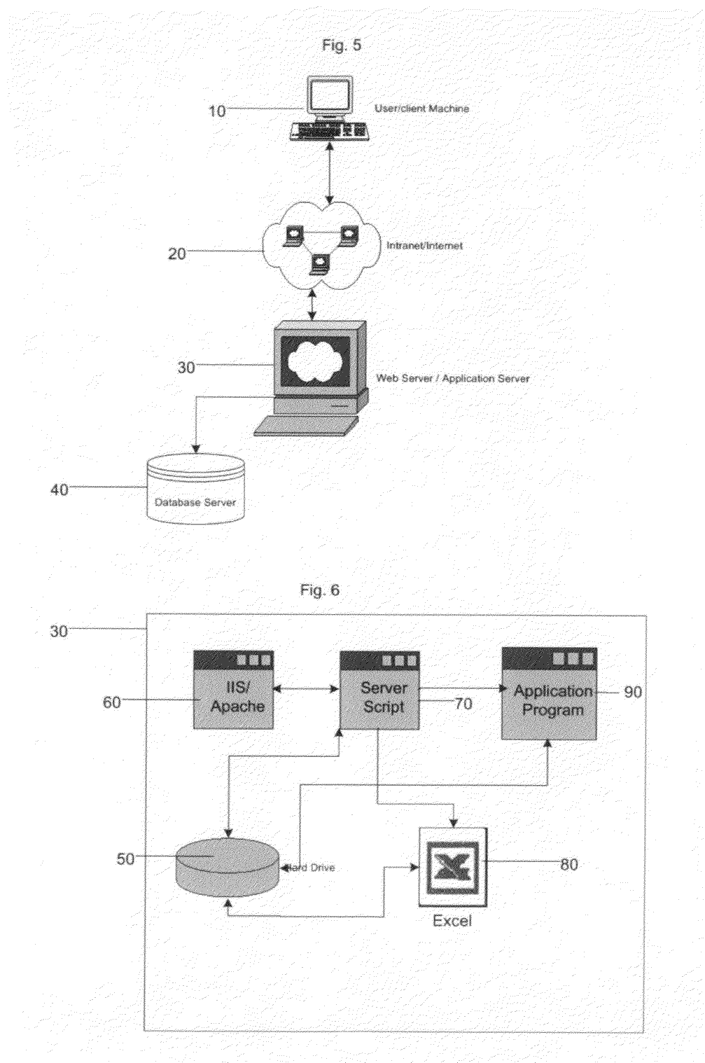

### Figures Used in Illustrating the User Interface and Output

The following figures we use to illustrate how the system work in a particular application, namely in the case of a inventory management of a Supermarket chain

FIG. 3 illustrates how an Inventory Optimization Screen looks like in a particular application. The figure is an example of a User interface used by Store Managers or regional Inventory Managers to compute inventory for each store of a chain called ‘Fresh Grocer Mart’. Interface lets one select Item of interest, initial price of item, sale price to mark down after certain no of days, cost of item, minimum units allowed to be stocked (i.e. if inventory calculated by the model, it will be constrained to the minimum allowed), and Week of year to define the current week, so that model would carry out the optimization by taking into account such factors as season, holidays, and other drivers of the demand beyond typical trend.

In optimizing the inventories of a large number of products simultaneously, the user input can be obtained from a file, such an Excel table, providing the user input for each product. This is easily accomplished by providing appropriate controls on user interface to upload such file from user desktop, file server, database, or any other storage device.

FIG. 4 illustrates how the output from the above application may look like when exported as an Excel pivot table. This figure shows a sample Excel pivot output that a user gets by running the web-based analytic. This gives the regional mangers of the supermarket a quick access to see optimal inventory by city, state or any regional parameters that are attributed for the store. They could also drill down to various store details and see the most granular details to enable them make appropriate decisions by individual store. Excel output also gives store level data in a separate Excel tab, which could be used by store managers in particular to view and handle their own store optimal inventory by product.

### Figures Illustrating the System Components

FIG. 5 & FIG. 6 are flow charts of the System modules of the application.

As described in above the demand model for each product is calibrated using data from in a database (FIG. 5-40). The statistical program used in estimation of model parameters can reside in statisticians desktop or in web server (FIG. 5-30). The demand model is updated periodically since model parameters tend to change over time.

In application of the model, FIGS. 5-10 shows an end user machine which is used to run the model for inventory optimization. The request is sent to a web server (FIG. 5-30) via internet or intranet (FIGS. 5-20). Web Server process the request using calibrated model parameters in a database (FIG. 5-40) or a file placed in the server itself. The output obtained by applying the calibrated model to current data and user input can also be saved in the server in the database.

Web Server FIG. 5-30 consist of a web server program like IIS (FIG. 6-60) which takes a request from a user and pass it to a server script (FIG. 6-70) which calls the statistical program that has the application (FIG. 6-90) code to optimize the inventory. The server script and the application program use data from a storage drive (FIG. 6-50) and user input parameters passed through the web interface. The current data and user input are applied to the latest calibrated model to optimize the inventory. The server script also creates the output in desired format such an Excel (FIG. 6-80) Pivot output containing store level details as well as rolled up data according to the default view of the pivot table. The output is sent back to the user running the model via Internet/Intranet. Also the server can send output to other users, who can apply optimized inventory, via email or other media.

### BEST MODE FOR CARRYING OUT THE INVENTION

This Invention is for inventory management based on statistical algorithms to build demand models and to optimize inventory based on such models. The best mode in the model calibration stage is to use a statistical programming language like SAS, Splus, or R to estimate parameters of the demand model. The SAS programming language is good to handle situations where one has to deal with large volumes of data, whereas SPlus is more convenient when historical data used in model calibration is moderate to low. On the other hand, SPuls or R script is most convenient in the implementation of the calibrated model using the SPlus Server or SpotFire BI Server, which allows writing of scripts in SPlus or R. Since the Invention allows a user to perform real-time inventory optimization using alternative user specified parameters, such as optimization constraints, it is best to save the calibrated model in a robust I/O environment. Although one can save the calibrated model in a database, since this requires only a small number of records of data, the best practice is to save the output as a text file or a Microsoft Excel file right on the server.

For the ease and availability of model as well as optimizing inventory one should use a web server to provide user interface that would work with scripting language thus enabling anyone can optimize the inventory or view data via internet or intranet. The Invention uses IIS web server. Windows scripting is used on server side to interpret web requests and to run SPlus programs performing analyses. Windows script also uses server side Excel template and script to automatically generate Excel Pivot output along with detailed data sheet. Outputs of CSV format for detailed data along with Excel pivot of rolled-up summary can be used by end users for inventory decision making and to feed to other systems if required.

The system could also provide modules that automatically deliver optimized inventory along with other useful data to certain users via email. When certain data used by the optimization algorithm or data used in preparation of the output comes from a database, it is best to pull such data from database and save right on the server periodically (e.g. once a day around midnight) rather than pulling such data for every user request. Most data in databases indeed changes only periodically, and so the task of pulling latest data automatically can be accomplished using the Windows scheduler or a cron job. It is convenient to write such scripts in a languages such as Perl. Similar scripts can also be created to run the inventory optimization algorithms automatically at a pre-specified time by calling appropriate SPlus functions to perform the optimizations, prepare output files with store/unit level information, and send them to pre-specified users via email.

### REFERENCES

1. Achabal, D. D., McIntyre, S. H., Smith, S. A. (1990), “Maximizing profits from Periodic department store promotions”, Journal of Retailing, Vol. 66, pp. 383-407.
2. Petruzzi, N. C., and Dada, M. (1999). “Pricing and Newsvendor Problem: A Review with Extensions”, Operations Research, Vol. 47, No. 2, 183-194.
3. Weerahandi (2012). “Generalized Point Estimation with Application to Small Response Estimation”, Communications in Statistics Theory and Methods, 41, 4069-4095.

1. An inventory management model that incorporates display effect, initial and sale price, seasonality, trend and store/branch attributes in the demand model.

2. Formulas and algorithms for the expected demand in the current period based on the model calibrated with historical sales data and widely used statistical distributions.

3. Formulas and algorithms for estimation of model parameters and writing scripts using a statistical software languages to compute the cost, the revenue, and the profit.

4.

5.

6.

7.

8. Formulas and algorithms to compute optimum inventory.

9. Obtaining user input such as the proposed sale price via a user interface and then optimizing inventory under user specified scenarios so as to maximize the expected profit.

10. A system that uses scripts built to compute inventory model and enabling users to run various scenarios real-time over the internet or intranet exporting optimal inventory, cost revenue, and profit information along with store attributes in a user specified file format.

11.
